(19) United States
(12) Patent Application Publication
(10) Pub. No.: US 2005/0061681 A1
(43) Pub. Date: Mar. 24, 2005

(54) Method for manufacturing heating pad using electrically conductive polymer

(76) Inventors: Jeong Ok Lim, Taegu (KR); Dong Won Park, Taegu (KR)

Correspondence Address: Yoon S. Ham, Esq.;Piper Rudnick LLP, P.O. Box 9271, Reston, VA, 20195, US

(21) Appl. No.: 10/914,626

(22) Filed: Aug. 10, 2004

Related U.S. Application Data
(63) Continuation-in-part of application No. 10/088,499, filed on Mar. 28, 2002.

(30) Foreign Application Priority Data
Sep. 30, 1999 (KR) 1999-41954

(51) Int. Cl. C25D 5/00; H05B 6/64

(52) U.S. Cl. 205/414; 205/81

(57) ABSTRACT

Disclosed is a method for manufacturing a heating pad using an electrically conductive polymer suitable for use in maintaining patients' body temperatures. A cloth made of a synthetic fiber or a natural fiber is treated in a bath containing dopants, distilled polymerizable monomers, and an oxidizer under such a high temperature and pressure that an electrically conductive polymer is chemically formed on the cloth. After being washed, the cloth is provided with a plurality of magnet couples arranged in a pattern in a electrical polymerization bath, wherein the plurality of magnet couples are arranged such that a first magnet of a couple is on a side of the cloth and a second magnet of the couple is on a side of a plate-shaped working electrode and opposite the first magnet to make close contact between the cloth and the working electrode by magnetic force, and the positively charged cations in the polymerization bath are attracted from an opposing electrode toward the working electrode under the influence of an electric field to form a polymeric coating on the cloth. The heating pad has a resistance of 10⁻²-10² Ω/cm². To the heating pad, a temperature sensor and controller are provided for safely maintaining patients' body temperatures.

### TECHNICAL FIELD

The present invention relates to a method for manufacturing a heating pad suitable for use in maintaining patients' body temperatures. More particularly, the present invention relates to the coating of an electrically conductive material, such as polypyrrole, polyaniline, or polythiophene, on a cloth in a chemical and an electrical polymerization process, so as to manufacture a heating pad which can safely maintain its temperature at least at 40±5° C. for 1-4 hours.

### PRIOR ART

Since most of the hospital buildings that have recently been constructed or remodeled adopt centrally controlled heating and cooling systems, it is virtually impossible to regulate the temperatures of individual rooms to accommodate every patient who is admitted to the hospitals. Thus, patients, who usually live in thin gowns for a long period of time in hospitals, are required to control and manage their own individual body temperatures. In particular, the patients who have just undergone surgical operations have difficulty in controlling their own body temperatures because of the stress and bleeding resulting from the operations and the exposure of internal organs to the outside for a long period of time. In fact, since the interior temperatures of hospitals are usually maintained at 22-24° C. all the year round, the patients on whom operations have just been performed cannot recover their normal body temperature immediately so that they may suffer from shivering and hypoxia.

To prevent such problems which lead the patients to suffer serious consequences, a hypothermic control system or a warming air inflation blanket is typically employed for use in maintaining the body temperature of the patients who have just undergone operations. Associated with a main body as large as an average washing machine, a hypothermic control system, in which warm water is circulated through a rubber mattress, is limitedly used. In addition, it is very expensive. As for the warming air inflation blanket, its function of warming patients is performed with warm air which is injected between double-sided covers. In addition to being expensive, this blanket, however, causes an environmental problem because it is disposable. Further, it is unpleasant to the touch because it is made of vinyl and non-woven fabrics. Swelling as warm air is injected, the blanket is inconvenient to cover patients with. Meanwhile, an electric blanket, which is extensively used for maintaining warmth, is prohibited from being used in hospitals because the electromagnetic waves generated during its operation may harm the patient and interfere with the operations of precision instruments in operating rooms, directly and indirectly. Furthermore, there is always the danger that the patient might receive an electric shock from the blanket because of the presence of water, such as physiological saline and blood, near the patient. Moreover, the patient may catch fire if the controller of the electric blanket is out of the order.

### DISCLOSURE OF THE INVENTION

It is an object of the present invention to overcome the above problems encountered in prior arts and to provide a method for manufacturing a heating pad which can safely generate heat by taking advantage of the heating properties of an electrically conductive polymer.

Based on the present invention, the above object could be accomplished by a provision of a method for manufacturing a heating pad using an electrically conductive polymer, comprising: a chemical polymerization process in which a cloth is treated with a solution containing dopants, distilled polymerizable monomers and an oxidizer at a high temperature under high pressure to coat the cloth with an electrically conductive polymer membrane, said cloth being composed of synthetic fibers or natural fibers; an electrical polymerization process in which the cloth is washed with water to detach weakly bonded polymeric materials therefrom and provided with a plurality of magnet couples arranged in a pattern in a polymerization bath, wherein the plurality of magnet couples are arranged such that a first magnet of a couple is on a side of the cloth and a second magnet of the couple is on a side of a plate-shaped working electrode and opposite the first magnet to make close contact between the cloth and the working electrode by magnetic force, and the positively charged cations in the polymerization bath are attracted from an opposing electrode toward the working electrode under the influence of an electric field to form a polymeric coating on the cloth; and an instrumenting process in which a temperature sensor and controller and a portable power supply are provided to the cloth.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a high temperature and pressure system for use in the chemical polymerization of electrically conducting monomers in accordance with an embodiment of the present invention;

FIG. 2 is a schematic view illustrating a polymerization bath system for use in the electrical polymerization process in accordance with an embodiment of the present invention;

FIG. 3 is a detailed view of item “A” in FIG. 2;

FIG. 4 is a schematic view illustrating a heating pad equipped with a temperature sensor and controller and a power supply;

FIG. 5 shows a temperature profile and a current profile of the heating pad, both of which are plotted with regard to time; and

FIG. 6 shows various applications of the heating pad.

### BEST MODES FOR CARRYING OUT THE INVENTION

The present invention is essentially composed of a chemical polymerization process for coating an electrically conductive polymer membrane on a gray cloth and an electrical polymerization process for growing a polymer membrane with the aid of a plurality of magnet couples arranged in a pattern.

In the chemical polymerization process, the electrically conductive polymer membrane is formed at about 50-150° C. under a pressure of 1-3 kgf/cm² by immersing a gray cloth in a bath containing dopants, polymerizable monomers, and an oxidizer. Suitable as the gray cloth is a synthetic fiber, such as a nylon fiber or a polyester fiber.

The electrical polymerization process is conducted by applying electrodes with a current density of 1-9 mA/cm² while N₂ gas is bubbled for stirring in a polymerization bath.

In order to provide the cloth with flexibility and an efficient heating structure, a pattern of a polymeric coating is formed on the cloth. In this regard, the cloth is provided with the plurality of magnet couples arranged in a pattern such that a polymer is allowed to grow thicker on the exposed areas of the cloth. Suitable for use as the polymeric material in the present invention are polypyrrole, polyaniline and polythiophene, all of which are electrically conductive. One or more of these electrically conductive polymers are coated by using a chemical and an electrical polymerization process in combination. A portable battery can be equipped on the heating pad to heat the heating pad to 40-45° C. Also, a temperature sensor and controller is provided for controlling the temperature of the heating pad at below 45° C. because the skin is burned if it is exposed to higher 45° C. for 1 hour or longer. Thus, the heating pad can be used safely.

A better understanding of the present invention may be obtained in light of the following examples which are illustrated with reference to the accompanying drawings and set forth to illustrate, but are not to be construed to limit the present invention.

### EXAMPLE

(1) Chemical Polymerization Process

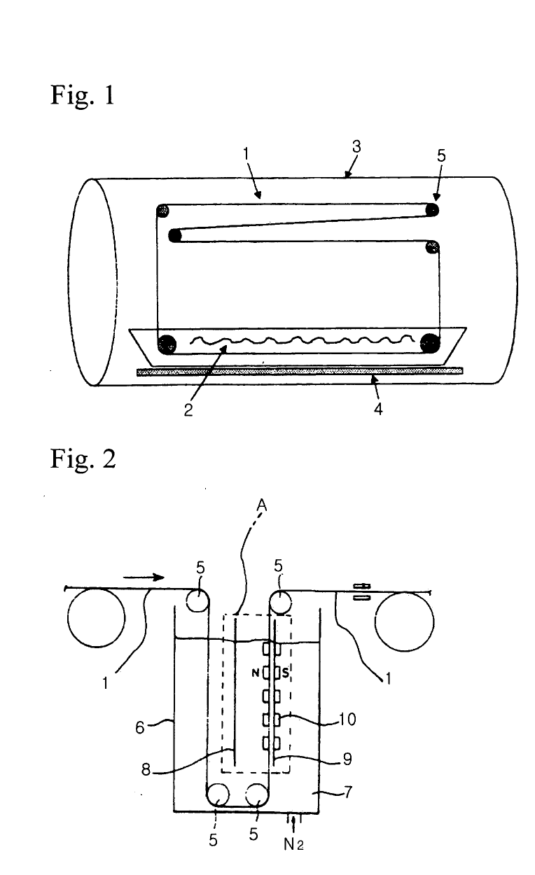

With reference to FIG. 1, there is a high-temperature, high-pressure system 3 in which chemical polymerization is conducted in accordance with an embodiment of the present invention. As illustrated in FIG. 1, a cloth 1, which is used as a substrate for the heating pad of the present invention, is repeatedly passed through a bath 2 containing dopants, distilled polymerizable monomers and an oxidizer while a chemical polymerization reaction occurs in the bath 2. To facilitate the chemical polymerization, the bath 2 is heated by a heater 4. During the chemical polymerization, the system 3 is maintained at about 50-150° C. under a pressure of 1-3 kgf/cm² for 3-100 min. The reason why such high temperature and pressure conditions are adopted is that, as in a dyeing process, the electrically conductive polymers obtained are forced to more actively impregnate into the cloth fibers under the high temperature and pressure conditions than under ordinary temperature and pressure conditions. Most of the polymers formed by the chemical polymerization stick to the cloth fibers via physical forces. After completion of the chemical polymerization, the cloth 1 is washed with water to detach the polymers which are weakly associated with the cloth 1. Afterward, the cloth 1 is dried at room temperature or in an oven to be an electrically conductive polymer-impregnated cloth 1.

(2) Electrical Polymerization Process

With reference to FIG. 2, a polymerization bath system 6 is provided for electrical polymerization according to an embodiment of the present invention. The electrical polymerization process occurs after the chemical polymerization process. In the polymerization bath system 6, the cloth 1, which is obtained in process (1), is allowed to undergo electrical polymerization with a solution 7 containing dopants and distilled polymerizable monomers. In this regard, a plate-shaped working electrode 9 is applied with a current density of 1-9 mA/cm² while the bath is bubbled from its bottom with N₂ gas for stirring. The cloth 1 is subjected to patterning with the aid of a plurality of magnet couples 10 to increase the amount of electrically conductive polymeric materials which are coated on the cloth 1 and to improve the quality of the coating. To achieve a preferred patterning result, the rotating speed of rollers 5 may be adjusted. Because the ions present in the polymerization bath system 6 are positively charged, the cations in the polymerization bath system 6 are attracted from a plate-shaped opposing electrode 8 (anode) toward the working electrode 9 (cathode) under the influence of the electric field formed, such that the cations coat the cloth 1, which closely contacts the working electrode 9. As a result, the cloth is found to be improved in surface morphology as observed with a microscope. In addition, the cloth 1 has a surface resistance of approximately 10 Ω/cm² (“cm²” is usually described as “□”, the unit area), which is lower than that of the cloth which is obtained by electrical polymerization using a patterning sheet.

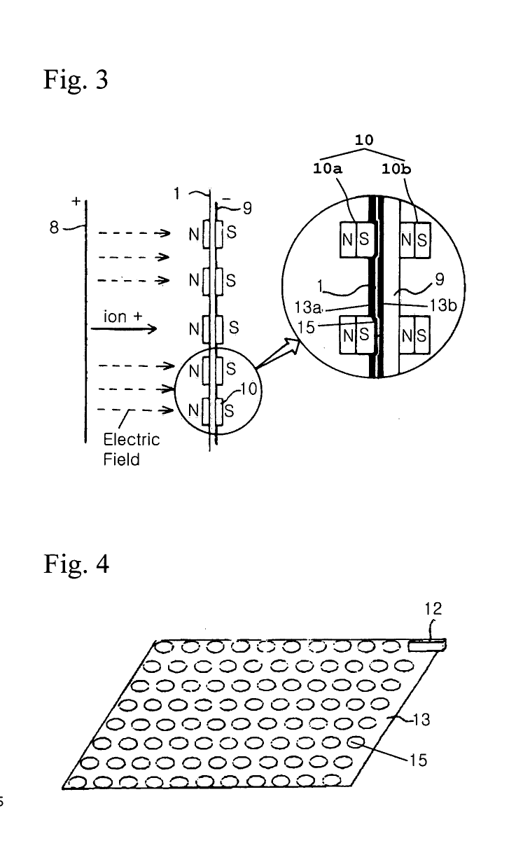

FIG. 3 is a detailed view of item “A” in FIG. 2. Referring to FIG. 3, there is shown a coating which is formed on the cloth 1 during the electrical polymerization. The plurality of magnet couples 10 is arranged such that a first magnet 10a of a couple 10 is on a side of the cloth 1 and a second magnet 10b of the couple 10 is on a side of the working electrode 9 and opposite the first magnet 10a, each magnet of which attracts the other magnet strongly like those shown in FIG. 3 by magnetic force. This helps the cloth 1 closely contact the plate-shaped working electrode 9 throughout the whole working area. And this makes a uniform gap between the cloth 1 and the working electrode 9 throughout the whole working area, and results in uniformity of the coating.

As a result of this close contact between the cloth 1 and the working electrode 9, a polymeric coating 13a, 13b grows thicker on the exposed areas of the cloth. At the same time, a polymeric coating 15 also grows on the non-exposed areas which are covered by magnets. But the coating 15 is thinner than that of the exposed areas, and this makes a coating pattern like that shown in FIG. 4.

The cations, which are attracted toward the working electrode 9 under the influence of the electric field and magnetic field, can be coated on the cloth 1 strongly by virtue of the close contact between the cloth 1 and the working electrode 9.

Once the treatment of the cloth 1 is completed, electrical polymerization is achieved. This electrical polymerization forms a pattern on the cloth, and makes the cloth a patterned sheet-type heating pad 13.

Because the ions present in the polymerization bath system 6 are positively charged, when N poles of the first magnets 10a face the plate-shaped opposing electrode 8, the cations in the polymerization bath are attracted more strongly toward the cloth 1 on the areas near the first magnets 10a under the influence of the magnetic field. And this results that a larger amount of electrically conductive polymer materials are coated on the areas near the first magnets 10a of the cloth 1. Also, the magnetic flux generated by the magnet couples 10 helps the mixing of the solution 7 in the polymerization bath system 6.

(3) Instrumenting Process

With reference to FIG. 4, the heating pad 13 is equipped with a temperature sensor, a temperature controller and a power supply 12, which is manufactured in accordance with the present invention. When prepared only through chemical polymerization, the cloth is found to range in resistance from approximately 10⁰ to 10² KΩ/cm². However, the coated areas of the cloth, which are provided with the electrical polymerization additionally, are measured to have a resistance of approximately 10⁻² to 10² Ω/cm². Therefore, electrical paths on the heating pad 13 occur along the coated parts (13a, 13b of FIG. 3). Complying with the Joule heating, the calorific power of the heating pad is represented by the following formula: Q=0.24 I² Rt (cal). Depending on the materials, the temperature of the heating pad increases according to the following formula: Q=Cₘm ΔT wherein Cₘ represents heat capacity and m represents a mass.

(4) A Temperature Profile of a Heating Pad

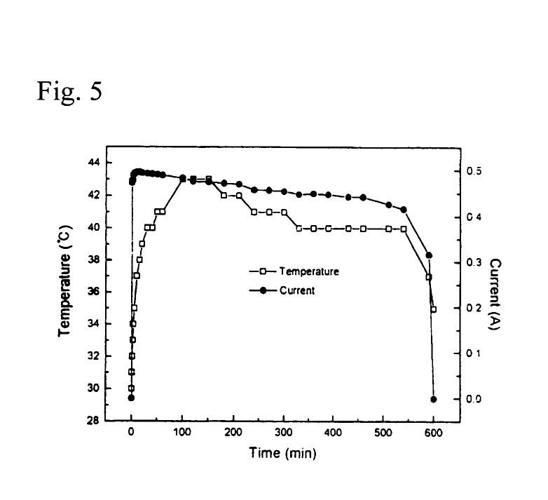

With reference to FIG. 5, there is a temperature profile of a heating pad manufactured in accordance with the present invention, which is plotted with regard to a period of time, along with a current profile provided to the heating pad. To obtain the temperature profile, a 12 V lithium ion battery was mounted on the heating pad which was then tested for heating. As shown in the temperature profile, the heating pad is heated to above 40° C. shortly after the supply of power from the battery and is maintained at more than 40° C. for 8 hours or longer.

### Industrial Applicability

As described hereinbefore, a heating pad can be manufactured by coating a cloth with an electrically conductive polymeric material, which generates no electromagnetic wavelengths harmful to the body, in a combination of a chemical and an electrical polymerization process. To the heating pad, a portable power supply is provided for generating heat and a temperature sensor and controller for controlling the temperature.

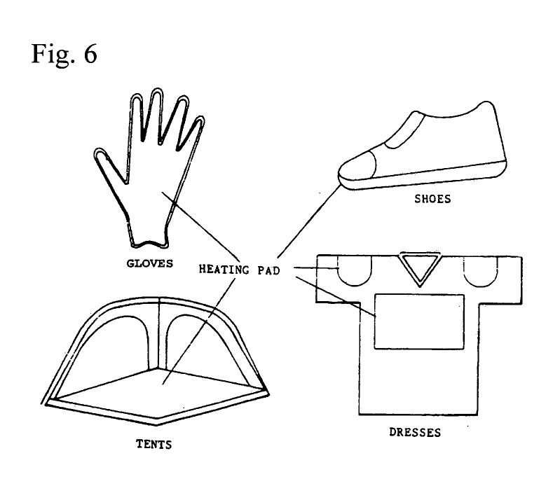

Although the heating pad of the present invention has been described for use in maintaining patients' body temperatures, it will be understood that the teachings herein can be applied to various products as well, including gloves, dresses, shoes, tents, etc., as shown in FIG. 6.

While the foregoing examples illustrate and describe the use of the present invention, they are not intended to limit the present invention as disclosed in certain preferred embodiments herein. Therefore, variations and modifications commensurate with the above teachings and the skill and/or knowledge of the relevant arts, are within the scope of the present invention.

1. A method for manufacturing a heating pad using an electrically conductive polymer, comprising:
a chemical polymerization process in which a cloth is treated with a solution containing dopants, distilled polymerizable monomers and an oxidizer at a high temperature under high pressure to coat the cloth with an electrically conductive polymer membrane, said cloth being composed of synthetic fibers or natural fibers;
an electrical polymerization process in which the cloth is washed with water to detach weakly bonded polymeric materials therefrom and provided with a plurality of magnet couples arranged in a pattern in a polymerization bath, wherein the plurality of magnet couples are arranged such that a first magnet of a couple is on a side of the cloth and a second magnet of the couple is on a side of a plate-shaped working electrode and opposite the first magnet to make close contact between the cloth and the working electrode by magnetic force, and the positively charged cations in the polymerization bath are attracted from an opposing electrode toward the working electrode under the influence of an electric field to form a polymeric coating on the cloth; and
an instrumenting process in which a temperature sensor and controller and a portable power supply are provided to the cloth.

2. A method as defined in claim 1, wherein said synthetic fibers are nylon or polyester.
